(19) United States
(12) Patent Application Publication
(10) Pub. No.: US 2017/0039873 A1
(43) Pub. Date: Feb. 9, 2017

(54) PROVIDING ADAPTIVE ELECTRONIC READING SUPPORT

(71) Applicant: FUJITSU LIMITED, Kawasaki-shi (JP)

(72) Inventors: Takuro WATANABE, Santa Clara, CA (US); Jun WANG, San Jose, CA (US); Kanji UCHINO, San Jose, CA (US)

(21) Appl. No.: 14/818,672

(22) Filed: Aug. 5, 2015

(51) Int. Cl. G09B 17/00

(52) U.S. Cl. CPC G09B 17/006

(57) ABSTRACT

A method may include estimating a current level of vocabulary knowledge of a learner. The method may also include determining a first vocabulary level of a first chunk in an electronic document read by the learner. Additionally, the method may include comparing the current level of vocabulary knowledge of the learner with the first vocabulary level of the first chunk. The method may further include determining whether to replace, in the electronic document, the first chunk with a second chunk of a vocabulary database based on the comparison of the current level with the first vocabulary level. The second chunk may have a second vocabulary level.

### FIELD

The embodiments discussed in the present disclosure are related to providing adaptive electronic reading support.

### BACKGROUND

Unless otherwise indicated, the materials described in the background section are not prior art to the claims in the present application and are not admitted to be prior art by inclusion in this section. Reading comprehension includes the ability to read, process, and understand text. There are a number of approaches to improve reading comprehension, including improving one's vocabulary.

The subject matter claimed in the present disclosure is not limited to embodiments that solve any disadvantages or that operate only in environments such as those described above. Rather, this background is only provided to illustrate one example technology area where some embodiments described may be practiced.

### SUMMARY

According to an aspect of an embodiment, a method may include estimating a current level of vocabulary knowledge of a learner. The method may also include determining a first vocabulary level of a first chunk in an electronic document read by the learner. Additionally, the method may include comparing the current level of vocabulary knowledge of the learner with the first vocabulary level of the first chunk. The method may further include determining whether to replace, in the electronic document, the first chunk with a second chunk of a vocabulary database based on the comparison of the current level with the first vocabulary level. The second chunk may have a second vocabulary level.

The object and advantages of the implementations will be realized and achieved at least by the elements, features, and combinations particularly pointed out in the claims.

It is to be understood that both the foregoing general description and the following detailed description are given as examples and explanatory and are not restrictive of the invention, as claimed.

### BRIEF DESCRIPTION OF THE DRAWINGS

Example embodiments will be described and explained with additional specificity and detail through use of the accompanying drawings in which:

FIG. 1 is a block diagram of an example operating environment related to providing adaptive electronic reading support;

FIG. 2 illustrates an example computing system that may be configured to provide adaptive electronic reading support;

FIG. 3 is a diagram illustrating an example personal vocabulary profile;

FIG. 4 is a block diagram illustrating an another example personal vocabulary profile;

FIG. 5 is a flowchart of an example method of updating a personal vocabulary profile;

FIG. 6 is a flowchart of an example method of providing adaptive electronic reading support;

FIG. 7 is a flowchart of an example method of estimating a current level of vocabulary knowledge of a learner;

FIGS. 8A-8B are a flowchart of an example method of reconstructing an electronic document; and

FIG. 9 is a flowchart of an example method of providing adaptive electronic reading support.

### DESCRIPTION OF EMBODIMENTS

It may be difficult for a learner to improve his or her reading skills using reading materials far beyond the learner's reading level. For example, if a learner attempts to improve his or her reading skills by reading a reading material that includes many difficult vocabulary terms that the learner does not comprehend, the learner may struggle to understand the reading material and may read sentences in the reading material over and over again. Some publishers may label reading materials (e.g., books) with a reading level, which is designed to help the learner more easily identify a reading material with an appropriate reading level for the learner. However, different publishers may base reading levels on different scales and factors, and lack of a consistent or unified definition of reading levels may facilitate selection by the learner of a reading material that is too far below or above the learner's reading level. Further, many reading materials are often not labeled with a reading level.

Moreover, reading levels provided by publishers are often broad and static, and learners with a range of reading skills may be grouped into a single reading level. Accordingly, one or more embodiments described in the present disclosure may provide personalized and adaptive electronic reading support to a learner. The personalized and adaptive electronic reading support may facilitate improvement of the learner's reading skills and/or comprehension by reconstructing a reading material such that it may have a level appropriate for the learner; e.g., such that the level is not too easy or too hard for the learner. In particular, in one or more embodiments described in the present disclosure, a reading material such as an electronic document may be reconstructed based on one or more of the following: the learner's current level of vocabulary knowledge, the learner's interest topics, and the learner's diligence level.

In one or more embodiments described in the present disclosure, reconstructing the electronic document may include comparing the learner's current level of vocabulary knowledge with a first vocabulary level of a first chunk in the electronic document and/or determining whether the first chunk is associated with one or more topics covered in one or more electronic documents read by the learner. In some embodiments, documents read by the learner may include documents requested and/or downloaded by the learner. The first chunk may include a word and/or phrase. In one or more embodiments described in the present disclosure, it may be determined whether to replace, in the electronic document, the first chunk with a second chunk that has a second vocabulary level based on one or more of the following: the comparison of the learner's current level of vocabulary knowledge with the first vocabulary level and/or whether the first chunk is associated with the topics covered in the electronic documents read by the learner.

For example, it may be determined that the first vocabulary level is higher than the learner's current level of vocabulary knowledge and/or that the first chunk is not associated with the topics covered in the electronic documents read by the learner, and based on this determination, the first chunk may be replaced in the electronic document with a particular second chunk that has a vocabulary level at the current level. As another example, it may be determined that the first vocabulary level is higher than the learner's current level of vocabulary knowledge and that the first chunk is associated with the topics covered in the electronic documents read by the learner, and based on this determination, the first chunk may not be replaced in the electronic document.

Further, in one or more embodiments described in the present disclosure, a diligence level of the learner may be determined based on a duration time between a marking of one or more chunks of a personal vocabulary profile of the learner as unstable chunks and a changing of the marking of the one or more chunks from being marked as unstable chunks to being marked as stable chunks in a personal vocabulary profile. The changing of the marking of the one or more chunks from unstable to stable may be in response to determining that the learner has mastered the one or more chunks. In these and other embodiments described in the present disclosure, a number of chunks in the electronic document may be replaced with chunks from a vocabulary level higher than the learner's current level of vocabulary knowledge, the number of chunks being based on the diligence level of the learner.

In the present disclosure, the term “chunk” may refer to a word and/or phrase. A phrase may include a set of words. In some embodiments, the chunks may be automatically identified and/or extracted from an electronic document. In some embodiments, a chunk may be included in a vocabulary database.

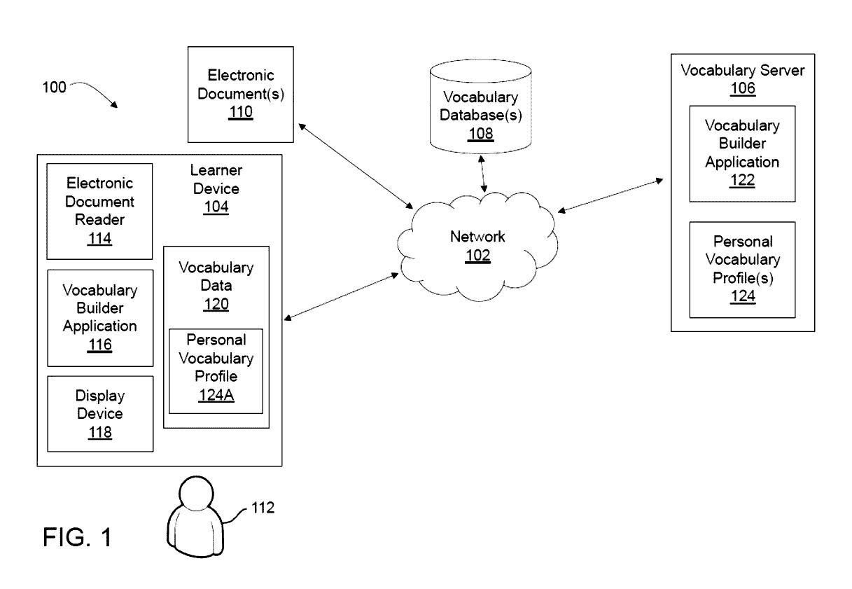

FIG. 1 is a block diagram of an example operating environment 100 related to providing adaptive electronic reading support, arranged in accordance with at least one embodiment described in the present disclosure. The operating environment may include a network 102, a learner device 104, a vocabulary server 106, one or more vocabulary databases each of a particular level (hereinafter “vocabulary database” or “vocabulary databases”) 108, one or more electronic documents 110, and a learner 112.

In general, the network 102 may include one or more wide area networks (WANs) and/or local area networks (LANs) that enable the learner devices 104 to access the electronic documents 110 and/or that enable one or more of the learner devices 104, the vocabulary server 106, and the vocabulary database 108 to communicate with each other. In some embodiments, the network 102 includes the Internet, including a global internetwork formed by logical and physical connections between multiple WANs and/or LANs. Alternately or additionally, the network 102 may include one or more cellular RF networks and/or one or more wired and/or wireless networks and components such as, but not limited to, 802.xx networks, Bluetooth access points, wireless access points, IP-based networks, or the like. The network 102 may also include computing systems (e.g., servers) that may enable one type of network to interface with another type of network.

The electronic documents 110 may include web pages, portable document format (“pdf documents”), word processing documents, or any other suitable type of other files that include at least some textual content. The electronic documents 110 may be hosted at one or more web servers (not shown) accessible to the learner device 104 via the network 102 or some other suitable communication interface. Alternately or additionally, the electronic documents 110 may be accessed locally on the learner device 104, may be exchanged via device-to-device communication between the learner device 104 and another of the devices or servers of FIG. 1, and/or may be exchanged via thumb drive or other computer storage medium.

The learner device 104 may include a desktop computer, a laptop computer, a tablet computer, a mobile phone, a smartphone, a personal electronic assistant (PDA), an e-reader device, or other suitable learner device. The learner device 104 may generally be configured to access and display electronic documents 110, including textual content, to the learners 112, and to build a vocabulary of the learners 112. In some embodiments, the learner device 104 may include an electronic document reader 114, a vocabulary builder application 116, vocabulary data 120, and a display device 118.

The electronic document reader 114 may be configured to render electronic documents that may include chunks, other textual content, and/or other content. Rendering an electronic document may include formatting and/or otherwise processing content of the electronic document for output to a display device, to be displayed on the display device. The electronic document reader 114 may include a web browser, an e-reader application, a .pdf reader, a word processor application, or other suitable document viewer and/or document editor.

The vocabulary builder application 116 may generally be configured to provide adaptive electronic reading support through the learner 112 reading electronic documents 110 reconstructed by the vocabulary builder application 116. The adaptive electronic reading support may improve efficiency and performance of the learner 112 in reading and/or vocabulary building. The learner 112 may read the electronic documents 110 for work, school, pleasure, and/or other purposes. In some embodiments, the vocabulary builder application 116 may be implemented as a plugin for the electronic document reader 114.

The vocabulary data 120 may include data used by the electronic document reader 114 and/or the vocabulary builder application 116. For instance, the vocabulary data 120 may include one or more electronic documents and/or a personal vocabulary profile 124A of the learner 112 or components thereof that are at least temporarily stored on or otherwise accessible to the learner device 104.

The display device 118 may generally be configured to display the electronic documents 110, including textual content, rendered by the electronic document reader 114. The display device 118 may include a built-in monitor of the learner device 104 implemented and included within a laptop computer, a tablet computer, a mobile phone, a smartphone, a PDA, an e-reader device, or other learner device with a built-in screen. Alternately or additionally, the display device 118 may include an external monitor, a projector, a television, or other suitable display device 118 that may be separate from and communicatively coupled to the learner device 104.

The vocabulary server 106 may host a vocabulary builder application 122 and/or one or more personal vocabulary profiles (hereinafter “personal vocabulary profile” or “personal vocabulary profiles”) 124 of one or more learners. The personal vocabulary profiles 124 may include the personal vocabulary profile 124A of the learner 112. The vocabulary builder application 122 may provide a server-based version of the vocabulary builder application 116, e.g., for use in a client-server relationship between the vocabulary server 106 and the learner device 104. In some embodiments, the vocabulary builder application 116 of the learner device 104 may generally include client-side components associated with improving efficiency and performance of the learner 112 in vocabulary building and reading while the vocabulary builder application 122 may generally include server-side components associated with improving efficiency and performance of the learner 112 in vocabulary building and reading.

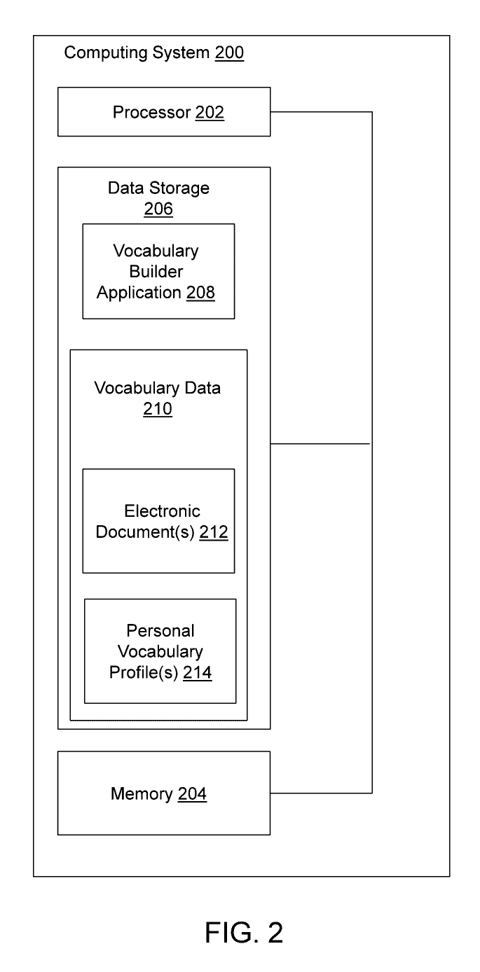

In some embodiments, one or both of the vocabulary builder applications 116, 122 may be implemented using hardware including a field-programmable gate array (FPGA) or an application-specific integrated circuit (ASIC). In some other embodiments, one or both of the vocabulary builder applications 116, 122 may be implemented using a combination of hardware and software or may be implemented in software as logic or instructions. The vocabulary builder applications 116, 122 may be stored in a combination of the devices and servers, or in one of the devices or servers of FIG. 1. An example embodiment of a vocabulary builder application that may correspond to one or both of the vocabulary builder applications 116, 122 is described below in more detail with respect to FIG. 2.

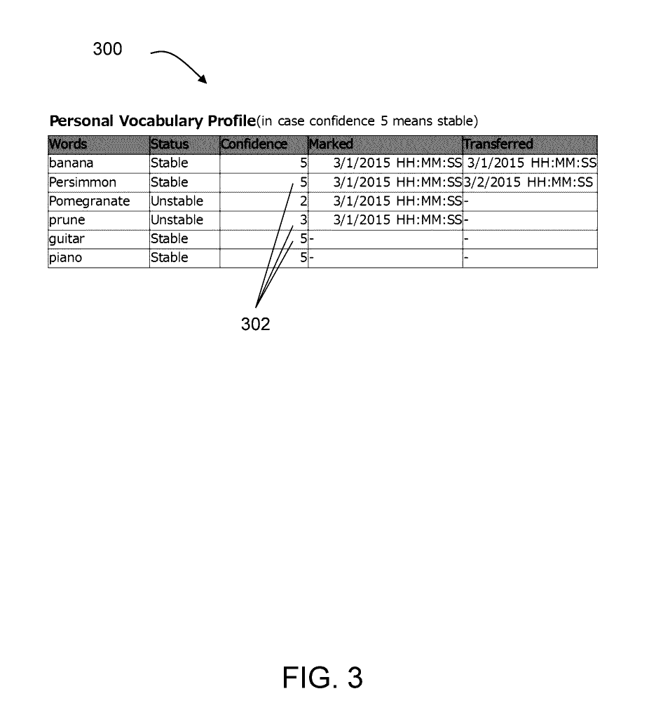

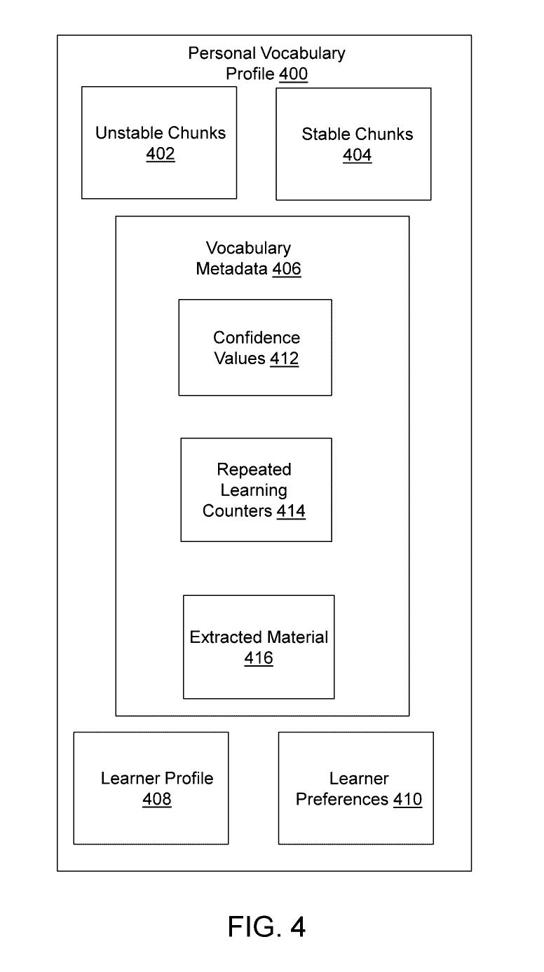

Each of the personal vocabulary profiles 124 may be associated with a different one learner. An example personal vocabulary profile that may correspond to the personal vocabulary profiles 124 is described in more detail with respect to FIGS. 3 and 4.

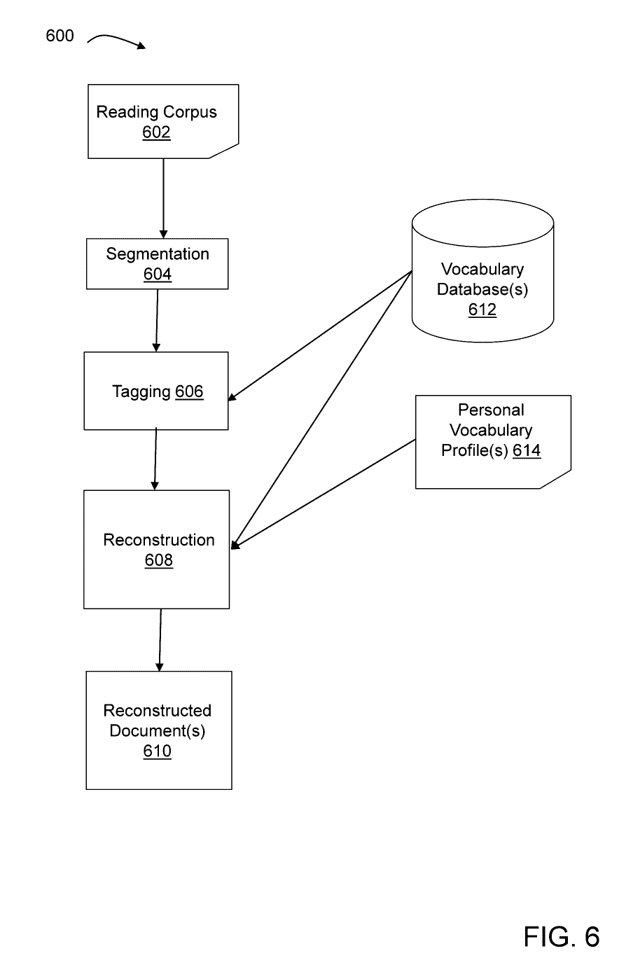

Each of the vocabulary databases 108 may include one or more chunks that belong to a particular level of vocabulary knowledge. The vocabulary databases 108 may be obtained from or based on levels of vocabulary knowledge defined by any organization, such as the organizations that administer the Test of English as a Foreign Language (TOEFL™) and/or the International English Language Testing System (IELTS™), or from other suitable sources. As will be described in more detail with respect to, e.g., FIG. 6, the vocabulary databases 108 may be used for one or more of the following: estimating a current level of vocabulary knowledge of the learners 112, determining a vocabulary level of a particular chunk in the electronic document 110, and providing chunks from the vocabulary database to replace chunks in the electronic document when the electronic document is reconstructed.

Modifications, additions, or omissions may be made to FIG. 1 without departing from the scope of the present disclosure. For example, the operating environment 100 may include more or fewer elements than those illustrated and described in the present disclosure.

FIG. 2 illustrates an example computing system 200 that may be configured to provide adaptive electronic reading support, arranged in accordance with at least one embodiment described in the present disclosure. The computing system 200 may include or correspond to the learner device 104 and/or the vocabulary server 106 of FIG. 1. The computing system 200 may include a processor 202, memory 204, and a data storage 206. The processor 202, the memory 204, and the data storage 206 may be communicatively coupled. The computing system 200 may be implemented as a computing device or computing system having any suitable form factor, such as a desktop computer, a laptop computer, a tablet computer, a mobile phone, a smartphone, a personal electronic assistant (PDA), an e-reader device, or other suitable computing device.

In some embodiments, a vocabulary builder application 208 may be embodied in logic or instructions resident in the data storage 206 for execution by the processor 202. The vocabulary builder application 208 may include or correspond to the vocabulary builder application 122 or the vocabulary builder application 116 of FIG. 1. The vocabulary builder application 208 may include instructions and data configured to cause the processor 202 to execute instructions that may cause the computing system 200 to perform one or more of the following, as will be explained later in more detail: segment, tag, and reconstruct an electronic document 212. In the present disclosure, reference to “performance” of operations by a vocabulary builder application (e.g., the vocabulary builder application 116, 122, or 208) may include performance of operations by a corresponding processor or computing system according to instructions or logic stored as the vocabulary builder application.

Additionally or alternatively, the data storage 206 may store vocabulary data 210. The vocabulary data 210 may include one or more electronic documents (hereinafter “electronic document” or “electronic documents”) 212 and one or more personal vocabulary profiles (hereinafter “personal vocabulary profile” or “personal vocabulary profiles”) 214. The vocabulary data 210 may correspond to the vocabulary data 120 of FIG. 1. Alternately or additionally, the electronic documents 212 may correspond to the electronic documents 110 and/or the personal vocabulary profiles 214 may correspond to the personal vocabulary profiles 124A and/or 124 of FIG. 1.

The processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other electronic or analog circuitry configured to interpret and/or to execute program instructions and/or to process data, including vocabulary data 210. Although illustrated as a single processor in FIG. 2, it is understood that the processor 202 may include any number of processors configured to perform individually or collectively any number of operations described in the present disclosure. Additionally, one or more of the processors may be present on one or more different electronic devices. In some embodiments, the processor 202 may interpret and/or execute program instructions and/or process data, including vocabulary data 210, stored in the data storage 206.

The memory 204 and the data storage 206 may include computer-readable storage media for carrying or having computer-executable instructions or data structures stored thereon. Such computer-readable storage media may be any available media that may be accessed by a general-purpose or special-purpose computer, such as the processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain function or group of functions.

An electronic document reader, for example, the electronic document reader 114 of FIG. 1, and/or the vocabulary builder application 208 may generally include software that includes programming code and/or computer-readable instructions executable by the computing system 200 to perform or control performance of the functions and operations described in the present disclosure. The vocabulary builder application 208 and/or the electronic document reader may receive data from another one of the components of the operating environment 100 of FIG. 1 and may store the data in one or both of the data storage 206 and/or the memory 204.

In some embodiments, the vocabulary builder application 208 may be generally configured to provide adaptive electronic reading support, which may improve the learner's reading comprehension, other reading skills, and build the learner's vocabulary. As described in detail in the present disclosure, to provide adaptive electronic reading support, in some embodiments, the vocabulary builder application 208 may be configured to segment one or more electronic documents 212 into chunks. Each chunk may include a word and/or a phrase.

In some embodiments, the vocabulary builder application 208 may be configured to segment the electronic documents 212 into chunks using a natural language processing tool such as the Natural Language Toolkit of the Python scripting language. For example, the sentence “I saw the big dog on the hill” may be segmented into chunks delineated by forward slash marks as follows: “I/saw/the/big/dog/on/the/hill.”

As described in detail in the present disclosure, to provide adaptive electronic reading support, in some embodiments, the vocabulary builder application 208 may be configured to assign one or more tags to each of the chunks based on one or more of the following: a topic of the chunk, a part of speech of the chunk, a vocabulary level of the chunk, and a meaning of the chunk. The vocabulary builder application 208 may be configured to assign one or more tags to each of the chunks in a vocabulary database and/or the electronic documents 212. In some embodiments, the vocabulary builder application 208 may be configured to perform a topic model analysis of the electronic documents 212 to identify multiple topics covered in the electronic documents. The vocabulary builder application 208 may be configured to identify a subset of the topics covered in the electronic documents 212 read by the learner, which may be referred to as the learner's topic distribution. For instance, the vocabulary builder application 208 may identify the learner's topic distribution by determining, based on the topics output by the topic model analysis, which of the topics are discussed in the electronic documents 212 read by the learner.

The vocabulary builder application 208 may be configured to analyze the electronic documents 212 to determine a part of speech for each of the chunks in the vocabulary database and/or the electronic documents. The part of speech of a particular chunk may be determined, for example, using a natural language processing tool such as the Natural Language Toolkit of the Python scripting language. The vocabulary builder application 208 may also be configured to analyze the electronic documents 212 to determine a meaning of each of the chunks of electronic documents 212. In some embodiments, the vocabulary builder application 208 may be trained on a corpus of data to determine meanings of chunks, and the meaning of each of the chunks of the electronic documents 212 may be determined by the vocabulary builder application 208 based on the corpus of data. In some embodiments, the vocabulary builder application 208 may search one or more vocabulary databases for the particular chunk and determine the vocabulary level of the chunk based on a level of the vocabulary database in which the particular chunk is located.

As described in detail in the present disclosure, to provide adaptive electronic reading support, in some embodiments, the vocabulary builder application 208 may be generally configured to reconstruct an electronic document 212 based on one or more of the following: the learner's current level of vocabulary knowledge, the learner's topic distribution, and the learner's diligence level. In particular, in some embodiments, the vocabulary builder application 224 may be configured to estimate a current level of vocabulary knowledge of the learner, as described in more detail in the present disclosure. In these and other embodiments, the vocabulary builder application 208 may be configured to compare the learner's current level of vocabulary knowledge with a first vocabulary level of a first chunk in the electronic document 212 and/or determine whether the first chunk is associated with the learner's topic distribution. In some embodiments, a particular chunk may be associated with the learner's topic distribution if the particular chunk has at least one topic in common with the learner's topic distribution. In some embodiments, the vocabulary builder application 208 may be configured to determine that the particular chunk is associated with at least one topic covered in one or more electronic documents read by the learner or the learner's topic distribution by comparing on one or more tags assigned to the particular chunk and one or more tags assigned to the electronic documents 212 read by the learner.

In some embodiments, the vocabulary builder application 208 may be configured to determine whether to replace, in the electronic document 212, the first chunk with a second chunk, which has a second vocabulary level, based on the comparison of the learner's current level of vocabulary knowledge with the first vocabulary level and/or whether the first chunk is associated with the learner's topic distribution.

For example, the vocabulary builder application 208 may be configured to determine that the first vocabulary level is higher than the learner's current level of vocabulary knowledge and/or that the first chunk is not associated with the learner's topic distribution, and based on this determination, the vocabulary builder application 208 may determine to replace, in the electronic document 212, the first chunk with a particular second chunk that has a vocabulary level at or below the learner's current level of vocabulary knowledge. As another example, the vocabulary builder application 208 may be configured to determine that the first vocabulary level is higher than the learner's current level of vocabulary knowledge and/or that the first chunk is associated with the learner's topic distribution, and based on this determination, the vocabulary builder application 208 may determine not to replace the first chunk in the electronic document 212. As a further example, the vocabulary builder application 208 may be configured to determine the first vocabulary level is lower than the learner's current level of vocabulary knowledge and/or the first chunk is not associated with the learner's topic distribution, and based on this determination, the vocabulary builder application 208 may determine not replace the first chunk in the electronic document 212. As yet another example, the vocabulary builder application 208 may be configured to determine the first vocabulary level is at or below the learner's current level of vocabulary knowledge and/or the first chunk is associated with the learner's topic distribution, and based on this determination, the vocabulary builder application 208 may determine to replace, in the electronic document 212, the first chunk with a particular second chunk that has a vocabulary level higher than the learner's current level of vocabulary knowledge.

In some embodiments, in response to determining to replace the first chunk with the second chunk, the vocabulary builder application 208 may be configured to retrieve the second chunk from a vocabulary database, for example, a particular vocabulary database 108 of FIG. 1, and to replace the first chunk with the second chunk in the electronic document 212. In response to determining to replace the first chunk in the electronic document 212 with a second chunk that has a vocabulary level higher, lower, or equal to the current vocabulary level of the learner, the vocabulary builder application 208 may be configured to select the second chunk from a vocabulary database, such as the vocabulary database 108. In some embodiments, the second chunk may be selected to replace the first chunk based on the second chunk having at least one of the following matching the first chunk: a part of speech, a topic, and a meaning, which may each be determined based on tags assigned to the second chunk in the vocabulary database.

Further, in some embodiments, the vocabulary builder application 208 may be configured to determine a diligence level of the learner. The diligence level of the learner may be determined based on a duration time (e.g., average duration) between a marking of one or more chunks of a personal vocabulary profile of the learner as unstable chunks and a changing of the marking of the one or more chunks from being marked as unstable chunks to being marked as stable chunks in a personal vocabulary profile. The changing of the marking of the one or more chunks from unstable to stable may be in response to determining that the learner has mastered the one or more chunks. In some embodiments, the vocabulary builder application 208 may determine a ratio of chunks marked stable in the personal vocabulary profile with respect to chunks marked unstable in the personal vocabulary profile. The stable chunks may be marked stable based on a determination that the learner has mastered the stable chunks, and the unstable chunks may be marked unstable based on a determination that the learner has not mastered the unstable chunks. In some embodiments, the vocabulary builder application 208 may be configured to determine the learner's diligence level by dividing the ratio by the duration of time.

In some embodiments, the vocabulary builder application 208 may determine the learner's diligence level by dividing the ratio by an average duration of time between a marking of the one or more chunks of the personal vocabulary profile of the learner as unstable chunks and the changing of the marking of the one or more chunks from being marked as unstable chunks to being marked as stable chunks in the personal vocabulary profile. As an example, referring now to FIG. 3, chunks corresponding to “banana,” “persimmon,” “pomegranate,” and “prune” may be marked as unstable in one or more electronic documents by the learner and/or in a personal vocabulary profile 300. A time at which each of the chunks corresponding to “banana,” “persimmon,” “pomegranate,” and “prune” is marked as an unstable chunk in the electronic documents and/or the personal vocabulary profile 300 may be recorded in the personal vocabulary profile. In response to a determination by the vocabulary builder application 208 that the learner has mastered one or more chunks, such as, for example, the chunks corresponding to “banana” and “persimmon,” a time at which each of the chunks is marked as a stable chunk in the personal vocabulary profile may be recorded in the personal vocabulary profile 300.

The vocabulary builder application 208 may determine that the learner has mastered the chunks in response to confidence values 302 included in the personal vocabulary profile 300 and associated with each of the one or more chunks reaching a counter threshold value. A difference between the time at which each of the chunks is marked as unstable in the electronic documents and/or the personal vocabulary profile 300 and the time at which each of the chunks is marked as stable in the personal vocabulary profile 300 may be determined by the vocabulary builder application 208. In some embodiments, the differences for each of the chunks that have been marked as stable in the personal vocabulary profile 300 may be averaged, and the learner's diligence level may be determined based on the average. Modifications, additions, or omissions may be made to the personal vocabulary profile 300 without departing from the scope of the present disclosure. For example, in some embodiments, the personal vocabulary profile 300 may include any number of other components that may not be explicitly illustrated or described.

Referring back to FIG. 2, in some embodiments, the vocabulary builder application 208 may be configured to replace a percentage of chunks in a particular electronic document with chunks from a vocabulary level higher than the learner's current level of vocabulary knowledge, the percentage of chunks being based on the diligence level of the learner. Specifically, in some embodiments, the vocabulary builder application 208 may be configured to replace a percentage of chunks, which have a vocabulary level equal to or lower than the learner's current level of vocabulary knowledge and are not associated with the topics covered by electronic documents read by the learner, with chunks from a vocabulary level higher than the current level based on the learner's diligence level. For example, the percentage of chunks that are replaced may be a first value in response to the learner having a diligence level that meets or exceeds a threshold level and a second value in response to the learner having a diligence level that is lower than the threshold level. The first value may be greater than the second value.

Modifications, additions, or omissions may be made to the computing system 200 without departing from the scope of the present disclosure. For example, in some embodiments, the computing system 200 may include any number of other components that may not be explicitly illustrated or described.

FIG. 4 is a block diagram illustrating another example personal vocabulary profile 400, arranged in accordance with at least one embodiment described in the present disclosure. In some embodiments, the personal vocabulary profile 400 may include or correspond to the personal vocabulary profile 300 of FIG. 3. The personal vocabulary profile 400 is an example of the personal vocabulary profiles 124 and 214 of FIGS. 1 and 2 and may be associated with a particular learner. As illustrated in FIG. 3, the personal vocabulary profile 400 may include one or more unstable chunks (hereinafter “unstable chunk” or “unstable chunks”) 402 and one or more stable chunks (hereinafter “stable chunk” or stable chunks”) 404. Alternately or additionally, the personal vocabulary profile 400 may include vocabulary metadata 406, a learner profile 408, and/or learner preferences 410.

The unstable chunks 402 may include chunks that are being learned by a learner, while the stable chunks 404 may include chunks that have been mastered by the learner. In some embodiments, a chunk is considered as having been mastered, and thus a stable chunk, if it has been read and understood by a learner at least a minimum number of times, while a chunk is considered as being learned, and thus an unstable chunk, if it has not been read and understood by the learner at least the minimum number of times. An unstable chunk may become a stable chunk after the unstable chunk has been read and understood by the learner at least the minimum number of times. Alternately or additionally, a stable chunk may become an unstable chunk if it is forgotten by the learner and the learner provides some indication that the stable chunk is no longer understood by the learner.

The vocabulary metadata 406 may include one or more of confidence values 412, repeated learning counters 414, and extracted material 416. The confidence values 412 may include a different confidence value for each of the unstable chunks 402. The confidence values for the unstable chunks 402 may each generally be represented by a variable C in the discussion of the present disclosure. Each of the confidence values 412 may indicate a number of times a corresponding one of the unstable chunks 402 is read and correctly understood by a learner, or a number of times in a row that the corresponding one of the unstable chunks 402 is read and correctly understood by the learner.

The repeated learning counters 414 may include a different repeated learning counter for each of the unstable chunks 402. The repeated learning counters for the unstable chunks 402 may each generally be represented by a variable R in the discussion of the present disclosure. Each of the repeated learning counters 414 may indicate a number of times a corresponding one of the unstable chunks 402 is read by the learner.

The extracted material 416 may include a context sentence for each of at least one of the unstable chunks 402. The context sentences may be extracted from electronic documents read by the learner. For example, the extracted material 416 may include context sentences for the unstable chunks 402, where the context sentences are extracted from electronic documents read by the learner. The context sentences in the extracted material 416 may be provided to the learner as an explanation of a corresponding unstable chunk included therein in response to the learner requesting such an explanation.

The learner profile 408 may include data that, at least in aggregate, uniquely identifies the learner. For example, the learner profile 408 may include one or more of a unique user id, a name, a username, an address, an e-mail address, a mobile phone number, a date of birth, or other information of the learner.

The learner preferences 410 may include one or more preferences of the learner with respect to building the learner's vocabulary. For example, the learner preferences 410 may indicate one or more topics of interest to the learner and/or other learner preferences. In some embodiments, the topics of interest to the learner may be determined based on and/or may correspond to topics covered by electronic documents read by the learner (hereinafter “learner's topic distribution”).

Referring now to FIGS. 2 and 4, an electronic document reader may render one of the electronic documents 212. A display device may display the rendered electronic document to the learner. The vocabulary builder application 208 may access the personal vocabulary profile 400 of the learner from the personal vocabulary profiles 214. The vocabulary builder application 208 may mark a chunk in the electronic document output to the display device 216 as an unstable chunk in response to the chunk in the electronic document being included in the unstable chunks 402 of the personal vocabulary profile 400. For example, the vocabulary builder application 208 may mark the chunk as an unstable chunk by causing the chunk to be highlighted or otherwise indicated as being an unstable chunk in the electronic document displayed on the display device 216.

The vocabulary builder application 208 may also receive input from the learner and determine whether the learner understands the chunk marked as the unstable chunk based on the received input. The input may be received through a user interface of the computing system 200, which user interface may include a mouse, keyboard, touchpad, touchscreen, or other input device. In some embodiments, the vocabulary builder application 208 may determine that the learner understands the chunk marked as the unstable chunk in response to the learner providing input effective to indicate that the learner understands the chunk. Alternately or additionally, the vocabulary builder application 208 may determine that the learner does not understand the chunk marked as the unstable chunk in response to the learner providing input effective to request an explanation of the chunk marked as the unstable chunk or to otherwise indicate that the learner does not understand the chunk marked as the unstable chunk. Alternately or additionally, the vocabulary builder application 208 may apply a default rule in which the chunk marked as the unstable chunk is determined as being understood by the learner in response to the learner not providing any input with respect to the chunk marked as the unstable chunk, e.g., it may be assumed that the learner understands the chunk marked as the unstable chunk unless the learner requests an explanation or otherwise indicates that it is not understood.

The vocabulary builder application 208 may update the personal vocabulary profile 400 to indicate whether the learner understands the chunk marked as the unstable chunk. The vocabulary builder application 208 may update the personal vocabulary profile by zeroing out or decrementation of a counter included in the personal vocabulary profile 400 and associated with the unstable chunk in response to a determination by the vocabulary builder application 208 that the learner does not understand the chunk marked as the unstable chunk. The counter may include a confidence value C of the unstable chunk included in the confidence values 412. Alternately or additionally, the profile module 224 may update the personal vocabulary profile by incrementation of the counter in response to a determination by the vocabulary learning module 226 that the learner understands the chunk marked as the unstable chunk. In some embodiments, the vocabulary builder application 208 may be further configured to, in response to incrementation of the counter to a counter threshold value M_C, change the unstable chunk to a stable chunk. For example, the personal vocabulary profile 400 may be updated such that the chunk is included in the stable chunks 404 rather than the unstable chunks 402. In some embodiments, the vocabulary builder application 208 may mark multiple chunks in the electronic document as unstable chunks in response to the multiple chunks in the electronic document being included in the unstable chunks 402 of the personal vocabulary profile 400.

The vocabulary builder application 208 may estimate the current level of vocabulary knowledge of the learner, which may include one or more of the following. The vocabulary builder application 208 may identify multiple chunks in the unstable chunks 402 and the stable chunks 404 that are also in a vocabulary database of a particular level of vocabulary knowledge, such as the vocabulary database 108. The vocabulary database may include a total number of chunks N. The vocabulary builder application 208 may calculate a first number S of the identified multiple chunks that are included in the stable chunks 404.

The vocabulary builder application 208 may calculate a discounted second number U of the identified multiple chunks that are included in the unstable chunks 402. The discounted second number U may be calculated in some embodiments as the sum of the confidence values C of the identified multiple chunks that are included in the unstable chunks 402 divided by the counter threshold value M_C. For example, if five of the identified multiple chunks are included in the unstable chunks 402 and have respective confidence values C within the confidence values 412 of the personal vocabulary profile 400 of 2, 6, 7, 1, and 5, and if the counter threshold value M_C is 8, then the discounted second number U may be calculated as: (2+6+7+1+5)/8=2.625 in some embodiments.

The vocabulary builder application 208 may calculate a coverage of the identified multiple chunks with respect to the vocabulary database based on the total number of chunks N in the vocabulary database, the first number S, and the discounted second number U. For example, the coverage may be calculated as (S+U)/N. When the calculated coverage is above a coverage threshold value, the vocabulary builder application 208 may determine that the current level of vocabulary knowledge of the learner is at least the particular level of the vocabulary database. When the calculated coverage is below the coverage threshold value, the vocabulary builder application 208 may determine that the current level of vocabulary knowledge of the learner is below the particular level. Alternately or additionally, the vocabulary builder application 208 may repeat the foregoing with respect to one or more other vocabulary databases of different particular levels until a current level of vocabulary knowledge of the learner is determined.

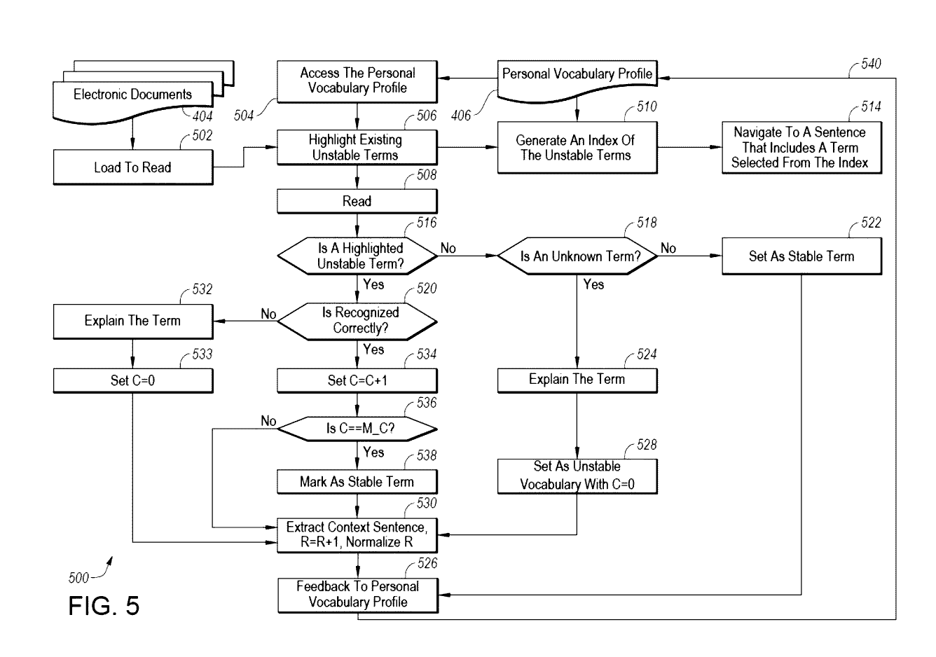

FIG. 5 illustrates an example flow diagram of a method 500 of updating a personal vocabulary profile, arranged in accordance with at least one embodiment described in the present disclosure. One or more operations of the method 500 may be implemented, in whole or in part and individually or collectively, by one or more of the learner device 104 the vocabulary server 106 of FIG. 1, the computing system 200 of FIG. 2, or another suitable device, server, and/or system. For example, in some embodiments, some or all of the method 500 may be performed by the vocabulary builder application 208 of FIG. 2 being executed on a suitable device, server, and/or system.

At block 502 (“Load To Read”), an electronic document may be rendered. For example, the electronic document may be rendered by the electronic document reader 114 of FIG. 1. Alternately or additionally, the method 500 may include displaying the rendered document on a display device, such as the display device 118 of FIG. 1. Block 502 may be followed by block 506, which will be described further below.

At block 504 (“Access The Personal Vocabulary Profile”), the personal vocabulary profile 400 of the learner may be accessed. For example, the personal vocabulary profile 400 may be accessed by the vocabulary builder application 208 of FIG. 2. Block 504 may be followed by block 506.

At block 506 (“Highlight Existing Unstable Terms”), terms in the electronic document may be marked as unstable terms in response to the terms being included in the unstable terms of the personal vocabulary profile 400. The terms may be marked by the vocabulary builder application 208 of FIG. 2. For example, the vocabulary builder application 208 may mark the terms as unstable terms by causing the terms to be highlighted or otherwise indicated as being unstable terms in the electronic document displayed on the display device. Block 506 may be followed by one or both of blocks 508 and 510.

At block 510 (“Generate An Index Of The Unstable Terms”), an index of unstable terms included in the electronic document displayed on the display device may be generated. The index may be generated by the vocabulary builder application 208 of FIG. 2. The index may be displayed on the display device. For example, the index of unstable terms may be displayed in a window such as a floating window within the displayed electronic document or in a separate window separate from the displayed electronic document, as a drop-down index, or in some other form on the display device. Input effective to select one of the unstable terms in the index may be received. The input may be received by the vocabulary builder application 208 of FIG. 2. The learner may provide the input using any suitable input device. Block 510 may be followed by block 514.

At block 514 (“Navigate To A Sentence That Includes A Term Selected From The Index”), the electronic document displayed on the display device may be navigated to a sentence that includes the selected term and/or an explanation of the selected term may be provided. The vocabulary builder application 208 of FIG. 2 may navigate to the sentence and/or provide the explanation. Navigating to the sentence that includes the selected term may include causing a portion of the electronic document that includes the sentence to be displayed on the display device. Alternately or additionally, navigating to the sentence that includes the selected term may include highlighting or otherwise marking the sentence. Navigating to the sentence may allow the learner to see the selected term in the context of the sentence within the electronic document. Providing an explanation of the selected term may include providing to the learner one or more of: a definition of the selected term, a translation of the selected term, and a context sentence that includes the selected term in context in a different electronic document. The explanation described here and elsewhere may be provided to the learner by causing the explanation to be displayed on the display device or otherwise output to the learner.

At block 508 (“Read”), the learner may read the electronic document displayed on the display device. Block 508 may be followed by block 516.

At block 516 (“Is A Highlighted Unstable Term?”), the learner may determine whether a term read by the learner is marked as an unstable term. For instance, if the term is highlighted or otherwise marked as an unstable term, the learner may determine that the term is marked as an unstable term. Block 516 may be followed by block 518 (“No” at block 516) or by block 520 (“Yes” at block 516).

At block 518 (“Is An Unknown Term?”), it is determined whether the term in the electronic document that is not marked as an unstable term is unknown to the user. The vocabulary builder application 208 of FIG. 2 may make the determination at block 518 based on input from the learner and/or based on an absence of input. For instance, the learner in some embodiments may provide input effective to indicate when the term that is not marked as an unstable term is unknown to the learner and may not provide any input when the term that is not marked as an unstable term is known to the learner. In these and other embodiments, the learner may use an input device to mark, select, or otherwise identify the term that is not marked as an unstable term when it is not understood by the learner.

In some embodiments, a user may forget terms that have been mastered already (e.g., stable terms in the personal vocabulary profile 400), and the user may provide input effective to indicate that the term is unknown to the learner such that it may be determined that the term is an unknown term. Thus, unknown terms may include terms the learner has not learned previously, as well as terms the learner has previously mastered and subsequently forgot. Block 518 may be followed by block 522 (“No” at block 518) or by block 524 (“Yes” at block 518).

At block 522 (“Set As Stable Term”), a term in the document that is not marked as an unstable term and that is determined to be known to the learner may be set as a stable term in the personal vocabulary profile 400 of the learner or may be confirmed as already included in the stable terms of the personal vocabulary profile 400 of the learner. The vocabulary builder application 208 of FIG. 2 may set the term as the stable term in the personal vocabulary profile or may confirm it is already included in the stable terms in the personal vocabulary profile. Setting the term as the stable term is an example of updating the personal vocabulary profile 400. Block 522 may be followed by block 526, to be described below.

At block 524 (“Explain The Term”), an explanation of a term in the document that is not marked as an unstable term and that is determined to be unknown to the learner may be provided to the learner. The explanation may be provided by the vocabulary builder application 208 of FIG. 2. Providing an explanation of the term may include providing to the learner one or more of: a definition of the term, a translation of the term, and a sentence that includes the term in context, where the sentence may be different than a sentence in the electronic document that includes the term. Block 524 may be followed by block 528.

At block 528 (“Set As Unstable Term With C=0”), the term in the document that is not marked as an unstable term and that is determined to be unknown to the learner may be added to the personal vocabulary profile 400 as an unstable term and a confidence value C of the term added to the personal vocabulary profile 400 as the unstable term may be initialized at zero. Alternately or additionally, a repeated learning counter R of the term added to the personal vocabulary profile 400 as the unstable term may be initialized at zero. The vocabulary builder application 208 of FIG. 2 may add the term as an unstable term to the personal vocabulary profile 400 and may initialize the confidence value C and repeated learning counter R of the term at zero. Block 528 may be followed by block 530, to be described below.

At block 520 (“Is Recognized Correctly?”), and in response to a term in the electronic document being marked as an unstable term, it is determined whether the learner understands the term marked as the unstable term. The determination at block 520 may be made by the vocabulary builder application 208 of FIG. 2. In these and other embodiments, when the term is marked in the electronic document as an unstable term, the learner may provide, via an input device, input effective to indicate whether the learner understands the term marked as the unstable term. The determination of whether the learner understands the term marked as the unstable term may thus be based on the received input. If it is determined that the term marked as the unstable term is not understood (“No” at block 520), the method 500 may proceed to block 532. If it is determined that the term marked as the unstable term is understood (“Yes” at block 520), the method 500 may proceed to block 534.

At block 532 (“Explain The Term”), and response to the determination that the learner does not understand the term marked as the unstable term, an explanation of the unstable term determined not to be understood by the learner may be provided to the learner. The explanation may be provided by the vocabulary builder application 208 of FIG. 2. Providing an explanation of the unstable term may include providing to the learner one or more of: a definition of the unstable term, a translation of the unstable term, and a sentence that includes the unstable term in context, where the sentence may be different than a sentence in the electronic document that includes the unstable term. Each of the foregoing may be considered a type of explanation. In some embodiments, a single one of the foregoing different types of explanations may be provided to the learner. Alternately or additionally, the learner may provide input effective to indicate which type of multiple available different types of explanations the learner would like to receive. Block 532 may be followed by block 533.

At block 533 (“Set C=0”), a confidence value C of the unstable term in the personal vocabulary profile 400 may be zeroed out. Alternately, the confidence value C may be decremented, e.g., by one or some other value. The vocabulary builder application 208 of FIG. 2 may zero out (or decrement) the confidence value C. Zeroing out (or decrementing) the confidence value C of the term marked as the unstable term is an example of updating the personal vocabulary profile 400. Block 533 may be followed by block 530, described in more detail below.

At block 534 (“Set C=C+1”), and responsive to the determination that the learner understands the term marked as the unstable term, the confidence value C of the unstable term in the personal vocabulary profile 400 may be incremented, e.g., by one or some other value. The vocabulary builder application 208 of FIG. 2 may increment the confidence value C. In some embodiments, the confidence value C for a given unstable term is incremented once per electronic document read by the learner if it is determined that the learner understands the term, even if the unstable term occurs multiple times in the same electronic document. In other embodiments, the confidence value C for a given unstable term is incremented each time the unstable term is determined to be understood by the learner, including incrementing the confidence value C multiple times if the unstable term occurs multiple times in a given electronic document and is determined to be understood by the learner each time it is read by the learner. Incrementing the confidence value C of the term marked as the unstable term is an example of updating the personal vocabulary profile 400 of FIG. 4. Block 534 may be followed by block 536.

At block 536 (“Is C==M_C?”), it may be determined whether the confidence value C of the unstable term in the personal vocabulary profile 406 is equal to the counter threshold value M_C. The determination may be made by the vocabulary builder application 208 of FIG. 2. If it is determined that the confidence value C is not equal to the counter threshold value M_C (“No” at block 536), block 536 may be followed by block 530. If it is determined that the confidence value C is equal to the counter threshold value M_C (“Yes” at block 536), block 536 may be followed by block 538.

The counter threshold value M_C may be set sufficiently high such that the learner's correct understanding of the unstable term M_C times in a row may indicate that the unstable term has been mastered, and is thus no longer an unstable term for the learner. Accordingly, at block 538 (“Mark As Stable Term”) and responsive to the confidence value C of the unstable term being determined to be equal to the counter threshold value M_C, the unstable term may be changed to a stable term in the personal vocabulary profile 400. The profile module 224 of FIG. 2 may change the unstable term to the stable term in the personal vocabulary profile 400 responsive to the confidence value C being determined to be equal to the counter threshold value M_C. In these and other embodiments, the counter threshold value M_C may be set by the learner and/or may be stored in learner preferences of the personal vocabulary profile 400. Alternately or additionally, a default value of the counter threshold value M_C may be determined by machine learning and/or may be automatically adjusted using machine learning over time for a given learner depending on how quickly the learner masters terms and/or whether the learner forgets terms that have been mastered. Changing the unstable term to a stable term in the personal vocabulary profile 400 is an example of updating the personal vocabulary profile 406. Block 538 may be followed by block 530.

At block 530 (“Extract Context Sentence, R=R+1, Normalize R”), a context sentence that includes the corresponding term from block 533, 536, 538, or 528 may be extracted from the electronic document. The context sentence may be extracted by the vocabulary builder application 208 of FIG. 2. The context sentence may be saved to the personal vocabulary profile 400, e.g., by the vocabulary builder application 208 of FIG. 2, and may be subsequently provided to the learner as an explanation of the corresponding term if such an explanation is requested by the learner when the learner is reading a different electronic document that includes the term. Extracting the context sentence from the electronic document and/or saving the extracted context sentence to the personal vocabulary profile 400 is/are an example of updating the personal vocabulary profile 400. FIG.

Alternately or additionally, at block 530, a repeated learning counter R of the corresponding term in the personal vocabulary profile 400 may be incremented, e.g., by one or some other value. The vocabulary builder application 208 of FIG. 2 may increment the repeated learning counter R. The repeated learning counter R for the corresponding term may be incremented once per electronic document in which the corresponding term occurs at least once, or may be incremented once per occurrence including multiple times for multiple occurrences in the same electronic document. Incrementing the repeated learning counter R for the corresponding term in the personal vocabulary profile 400 is an example of updating the personal vocabulary profile 400.

Alternately or additionally, at block 530, the repeated learning counter R of the corresponding term may be normalized by its frequency distribution in a reading corpus that may include all or at least some of the electronic documents read by one or more learners. Normalizing the repeated learning counter R for the corresponding term in the personal vocabulary profile 400 is an example of updating the personal vocabulary profile 400 as described with respect to FIG. 4. Block 530 may be followed by block 526.

At block 526 (“Feedback To Personal Vocabulary Profile”), one or more updates made to the personal vocabulary profile 400, e.g., as described with respect to blocks 522, 528, 533, 534, 538, and 530, may be accomplished by sending one or more corresponding write commands to a memory or storage on which the personal vocabulary profile is stored.

The method 500 may loop as the learner continues reading the electronic document, returning from block 526 to block 504, as denoted by the arrow 540, until the learner finishes reading the electronic document, closes the electronic document, and/or stops providing input for execution of the method 500. Alternately one or more of the operations of the method 500 of FIG. 5 may be repeated and/or omitted for different terms encountered by the learner as the learner reads the electronic document.

FIG. 6 is a flowchart of an example method 600 of providing adaptive electronic reading support for a learner, arranged in accordance with at least one embodiment described in the present disclosure. The method 600 may be implemented, in whole or in part and individually or collectively, by one or more of the learner device 104, the vocabulary server 106 of FIG. 1, the computing system 200 of FIG. 2, or another suitable device, server, and/or system. For example, in some embodiments, some or all of the method 600 may be performed by the vocabulary builder application 208 of FIG. 2 being executed on a suitable device, server, and/or system.

A reading corpus 602 may include electronic documents read by multiple learners (including the learner). The reading corpus 602 may include all or some of the electronic documents read by the learners ever or for a particular duration of time. Accordingly, the personal vocabulary profile 614 of each of the learners may be updated to include a listing of or otherwise indicate the electronic documents that have been read by the learner.

The method 600 may be performed on the reading corpus 602 prior to receipt of a request for a particular electronic document or reconstructed electronic document from the learner. In some embodiments, the method 600 may be performed on one or more electronic documents upon receipt of a request from the learner.

The electronic documents of the reading corpus 602 may correspond to the electronic documents 110 of FIG. 1, the electronic documents 212 of FIG. 2, or other electronic documents described in the present disclosure. The personal vocabulary profile 614 may include or correspond to the personal vocabulary profiles 124 of FIG. 1, the personal vocabulary profile 214 of FIG. 2, the personal vocabulary profile 300 of FIG. 3, the personal vocabulary profile 400 of FIG. 4, or other personal vocabulary profiles described in the present disclosure. The method 600 may begin at block 604.

At block 604, one or more electronic documents of the reading corpus 602 may be segmented into chunks. In some embodiments, the electronic documents of the reading corpus 602 may be segmented into chunks using a natural language processing tool such as the Natural Language Toolkit of the Python scripting language. Block 604 may be followed by block 606.

At block 606, the chunks of the electronic documents may each be assigned one or more tags. In some embodiments, the tags may be assigned to the chunks in the vocabulary database 612 in the electronic documents and/or the personal vocabulary profile 614. In some embodiments, the tags may be based on one or more of the following: one or more topics of the corresponding chunk, a part of speech of the corresponding chunk, a vocabulary level of the corresponding chunk, and a meaning of the corresponding chunk. In some embodiments, a topic model analysis of the reading corpus may be performed to identify multiple topics covered in the reading corpus, and the chunks may each be assigned the tags based on results of the topic model analysis. In some embodiments, a “topic” determined or output by the topic model analysis may include a probability distribution of chunks.

A subset of the topics covered in the electronic documents read by the learner, which may be referred to as the learner's topic distribution, may be identified. For instance, the learner's topic distribution may be identified by determining, based on the topics output by the topic model analysis, which of the topics are discussed in the electronic documents read by the learner.

In some embodiments, the part of speech of each of the chunks may be determined, for example, using a natural language processing tool such as the Natural Language Toolkit of the Python scripting language. In some embodiments, the meaning of each of the chunks of electronic documents of the reading corpus may be determined based on a corpus of trained data. In some embodiments, one or more vocabulary databases 612 may be searched to locate a particular chunk in the reading corpus 602 of electronic documents. In some embodiments, chunks in the vocabulary databases 612 may be labeled with one or more of the following: a part of speech, meaning, vocabulary level, and a topic, which may also each be determined for the particular chunk based on matching the particular chunk with a same chunk in the vocabulary databases 612. Block 606 may be followed by block 608.

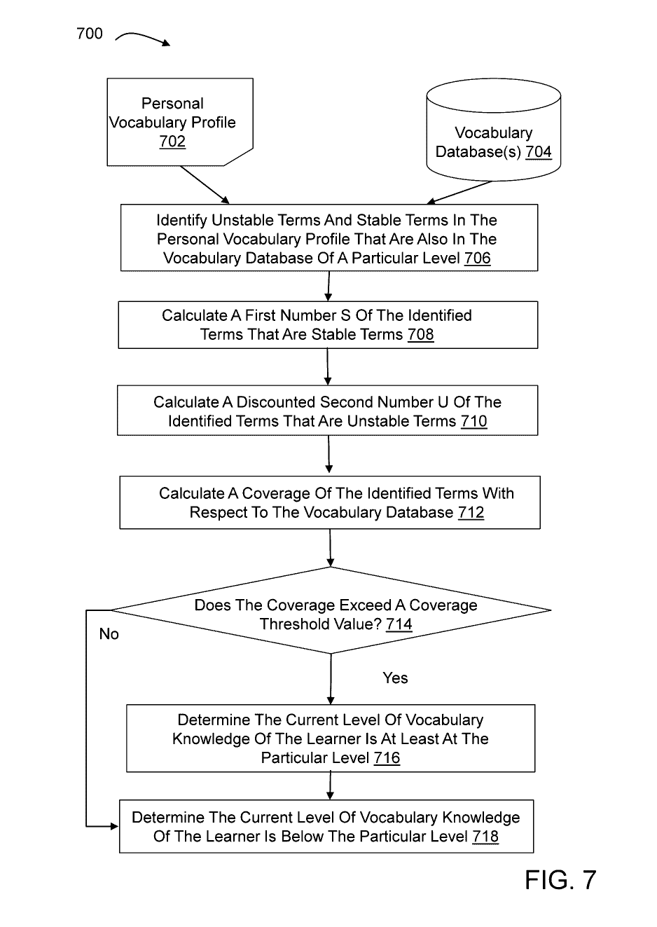

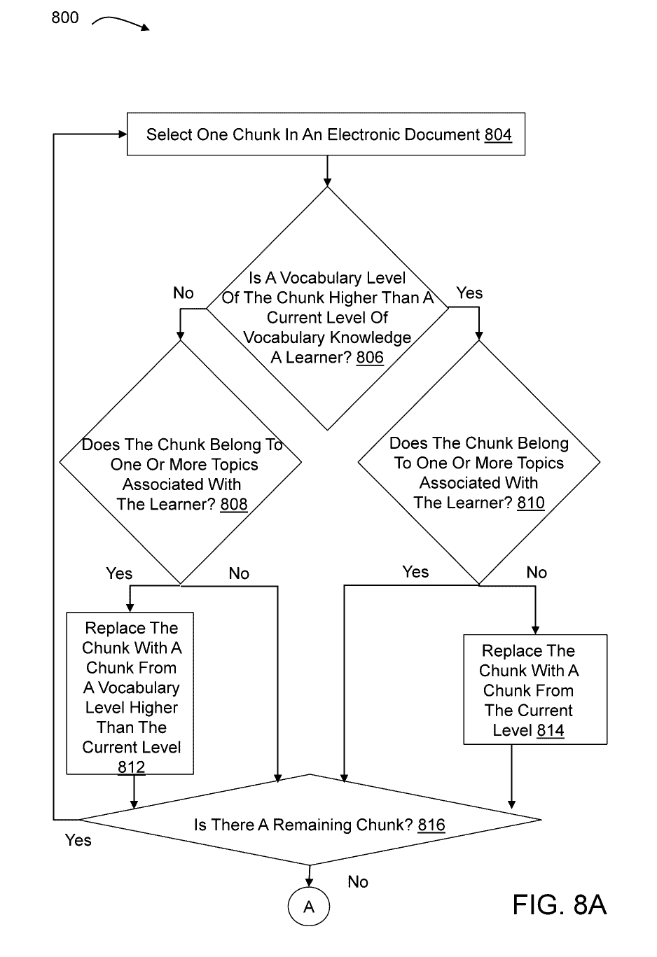

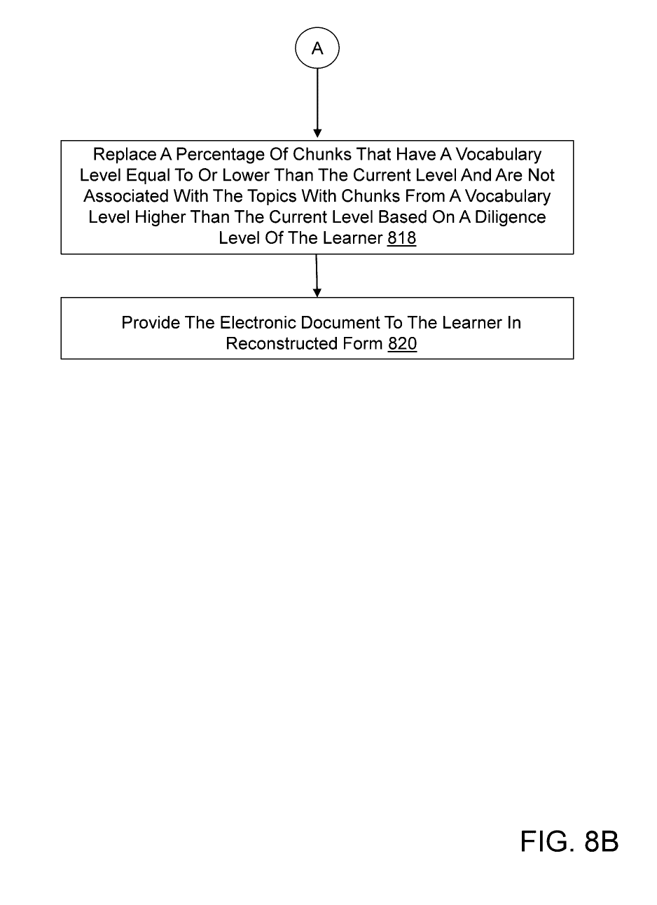

At block 608, the electronic documents of the reading corpus 602 may be reconstructed, creating reconstructed electronic documents 610. The learner's current level of vocabulary knowledge may be determined or estimated to reconstruct the electronic documents. An example method to estimate the learner's current level of vocabulary knowledge is described with respect to FIG. 7. An example method to reconstruct an electronic document is described with respect to FIGS. 8A-8B. Reconstruction of a particular electronic document may include replacing a chunk in the electronic document with another chunk from the vocabulary database 612.

Modifications, additions, or omissions may be made to the method 600 without departing from the scope of the present disclosure. For example, the functions performed in the method 600 may be implemented in differing order. Furthermore, the outlined acts and operations are only provided as examples, and some of the acts and operations may be optional, combined into fewer acts and operations, or expanded into additional acts and operations without detracting from the essence of the disclosed embodiments.

FIG. 7 is a flowchart of an example method 700 of estimating a current level of vocabulary knowledge of a learner, arranged in accordance with at least one embodiment described in the present disclosure. One or more operations of the method 700 may be implemented, in whole or in part and individually or collectively, by one or more of the learner device 104, the vocabulary server 106 of FIG. 1, the computing system 200 of FIG. 2, or another suitable device, server, and/or system. For example, in some embodiments, some or all of the method 700 of FIG. 7 may be performed by the vocabulary builder application 208 of FIG. 2 being executed on a suitable device, server, and/or system.

The estimation of the current level of vocabulary knowledge of the learner may be implemented using a personal vocabulary profile 702 of the learner and/or one or more vocabulary databases each of a particular level (hereinafter “vocabulary database” or “vocabulary databases”) 704. The personal vocabulary profile 702 may be included in or correspond to the personal vocabulary profiles 124 of FIG. 1, the personal vocabulary profiles 222 of FIG. 2, the personal vocabulary profile 300 of FIG. 3, the personal vocabulary profile 400 of FIG. 4, or other personal vocabulary profiles described in the present disclosure. The vocabulary database 704 may correspond to or include the vocabulary database 108 of FIG. 1 or other vocabulary databases described in the present disclosure. The method 700 may begin at block 706.

At block 706, unstable terms and stable terms in the personal vocabulary profile 702 may be identified that are also in the vocabulary database 704 of the particular level. The vocabulary database 704 may include a total number of terms N. Block 706 may be followed by block 708.

At block 708, a first number S of the identified stable terms may be calculated. For example, in some embodiments, the number of stable terms from the personal vocabulary profile 702 that are identified as also being in the vocabulary database 704 may be counted to calculate the first number S. Block 708 may be followed by block 710.

At block 710, a discounted second number U of the identified unstable terms may be calculated. For example, in some embodiments, confidence values C of the unstable terms from the personal vocabulary profile 702 that are identified as also being in the vocabulary database 704 may be summed and the sum may be divided by the counter threshold value M_C to calculate the discounted second number U. Block 710 may be followed by block 712.

At block 712, a coverage of the identified stable and unstable terms with respect to the vocabulary database 704 may be calculated. The calculation of the coverage with respect to the vocabulary database 704 may be based on the total number of terms N in the vocabulary database, the first number S, and the discounted second number U. For example, the coverage may be calculated as (S+U)/N. It may be seen from blocks 708, 710, and 712 and the calculations involved therein that each stable term that is included in the vocabulary database 704 may generally contribute equally to the calculated coverage, while each unstable term that is included in the vocabulary database 704 may contribute a discounted amount to the calculated coverage, where the discounted amount contributed by each unstable term increases with increasing confidence value C. Block 712 may be followed by block 714.

At block 714, it may be determined whether the coverage exceeds a coverage threshold value. The determination may be made by comparing the calculated coverage to the coverage threshold value and determining which is greater. Block 714 may be followed by block 716 (“Yes” at block 714) or by block 718 (“No” at block 714).

At block 716, and responsive to a determination that the calculated coverage exceeds the coverage threshold value, it may be determined that the current level of vocabulary knowledge of the learner is at least at the particular level, which may be thereafter referred to as the estimated current level of vocabulary knowledge of the learner. In some embodiments, and each time the current level of vocabulary knowledge of the learner is determined to be at least the particular level, the method 700 may repeat using a vocabulary database of a higher level (e.g., greater difficulty) until the calculated coverage does not exceed the coverage threshold value. In these and other embodiments, the highest level of vocabulary database for which the calculated coverage exceeds the coverage threshold value may be determined as the current level of vocabulary knowledge of the learner.

At block 718, and responsive to a determination that the calculated coverage does not exceed the coverage threshold value, it may be determined that the current level of vocabulary knowledge of the learner is below the particular level. In some embodiments, and each time the current level of vocabulary knowledge of the learner is determined to be below the particular level, the method 700 may repeat using a vocabulary database of a lower level (e.g., less difficult) until the calculated coverage exceeds the coverage threshold value. In these and other embodiments, the level of vocabulary database for which the calculated coverage exceeds the coverage threshold value may be determined as the current level of vocabulary knowledge of the learner.

Modifications, additions, or omissions may be made to the method 700 without departing from the scope of the present disclosure. For example, the functions performed in the method 700 may be implemented in differing order. Furthermore, the outlined acts and operations are only provided as examples, and some of the acts and operations may be optional, combined into fewer acts and operations, or expanded into additional acts and operations without detracting from the essence of the disclosed embodiments.

FIGS. 8A-8B are a flowchart of an example method 800 of reconstructing an electronic document, arranged in accordance with at least one embodiment described in the present disclosure. One or more operations of the method 800 may be implemented, in whole or in part and individually or collectively, by one or more the learner device 104, vocabulary server 106 of FIG. 1, the computing system 200 of FIG. 2, or another suitable device, server, and/or system. For example, in some embodiments, some or all of the method 600 may be performed by the vocabulary builder application 208 of FIG. 2 being executed on a suitable device, server, and/or system.

The method 800 may begin at block 804 where a chunk in an electronic document to be reconstructed may be selected. Block 804 may be followed by block 806.

At block 806, it may be determined if a vocabulary level of the chunk is higher than a current level of vocabulary knowledge of a learner. Block 806 may be followed by block 810 if it is determined that the vocabulary level of the chunk is higher than the current level of vocabulary knowledge (“Yes” at block 806) or by block 808 if it is determined that the vocabulary level of the chunk is not higher than the current level of vocabulary knowledge (“No” at block 806).

At block 810 it may be determined if the chunk belongs to one or more topics associated with the learner. In some embodiments, it may be determined that the chunk belongs to one or more topics associated with the learner by comparing one or more tags assigned to the chunk and one or more tags assigned to electronic documents read by the learner to see if at least one tag is shared. Block 810 may be followed by block 816 if it is determined that the chunk belongs to one or more topics associated with the learner (“Yes” at block 810) or by block 814 if it is determined that the chunk does not belong to one or more topics associated with the learner (“No” at block 810).

At block 814, the chunk may be replaced with a chunk from the current level of vocabulary knowledge. At least one of the following: a part of speech, a meaning, and/or a topic, of the chunk from the current level of vocabulary knowledge may match a part of speech, a meaning, and a topic of the chunk that is replaced. Block 814 may be followed by block 816.

At block 808, it may be determined if the chunk belongs to one or more topics associated with the learner. In some embodiments, it may be determined that the chunk belongs to one or more topics associated with the learner by comparing one or more tags assigned to the chunk and one or more tags assigned to electronic documents read by the learner to see if at least one tag is shared. Block 808 may be followed by block 812 if it is determined that the chunk belongs to one or more topics associated with the learner (“Yes” at block 808) or by block 816 if it is determined that the chunk does not belong to one or more topics associated with the learner (“No” at block 808).

At block 812, the chunk may be replaced with a chunk from a vocabulary level higher that the current level of vocabulary knowledge. At least one of the following: a part of speech, a meaning, and/or a topic, of the chunk from the vocabulary level higher than the current level of vocabulary knowledge may match a part of speech, a meaning, and a topic of the chunk that is replaced. Block 812 may be followed by block 816.

At block 816, it may be determined if a chunk remains to be analyzed in the electronic document. Block 816 may be followed by block 804 if it is determined that there is a remaining chunk (“Yes” at block 816) or by block 818 if it is determined that there is not a remaining chunk (“No” at block 816).

At block 818, a percentage of chunks that have a vocabulary level equal to or lower than the current level and are not associated with the one or more topics associated with the learner may be replaced with chunks from a vocabulary level higher than the current level of vocabulary knowledge. The percentage of chunks that are replaced may be based on a diligence level of the learner. Block 818 may be followed by block 820.

At block 820, the electronic document may be provided to the learner in reconstructed form. For example, one or more chunks in the electronic document may be replaced with chunks from the vocabulary databases.

Modifications, additions, or omissions may be made to the method 800 without departing from the scope of the present disclosure. For example, the functions performed in the method 800 may be implemented in differing order. Furthermore, the outlined acts and operations are only provided as examples, and some of the acts and operations may be optional, combined into fewer acts and operations, or expanded into additional acts and operations without detracting from the essence of the disclosed embodiments. For example, one or more of the following blocks may not be used: block 808, block 810, block 812, block 814, block 818, and block 820. As another example, multiple chunks in the electronic document may be analyzed at the same time as opposed to sequentially. The multiple chunks may be analyzed in any order, at the same time, or differing times.

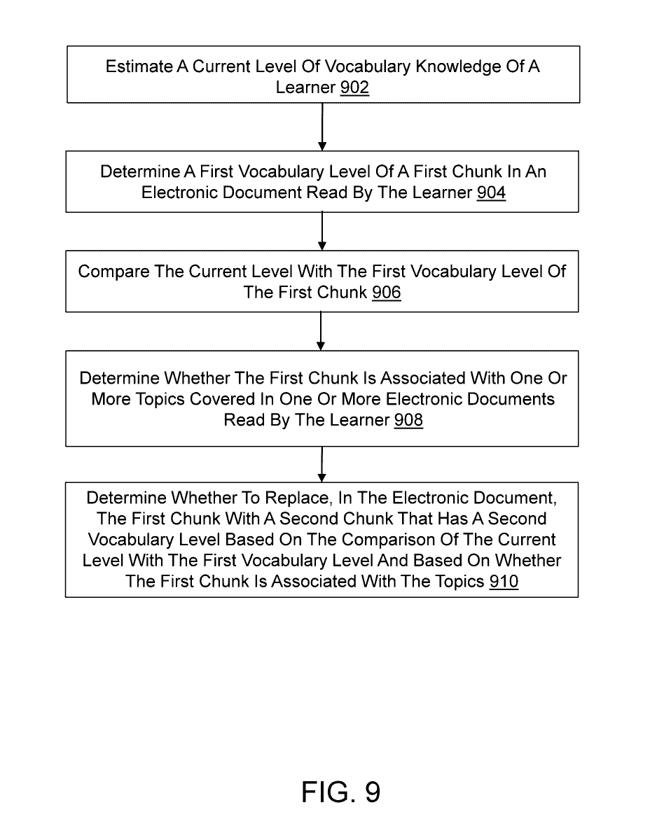

FIG. 9 is a flowchart of an example method 900 of providing adaptive electronic reading support, arranged in accordance with at least one embodiment described in the present disclosure. One or more operations of method 900 may be implemented, in whole or in part and individually or collectively, by one or more of the learner device 104 and the vocabulary server 106 of FIG. 1, the computing system 200 of FIG. 2, or another suitable device, server, and/or system. For example, in some embodiments, some or all of the method 900 may be performed by the vocabulary builder application 208 of FIG. 2 being executed on a suitable device, server, and/or system.

The method 900 may begin at block 902, where a current level of vocabulary knowledge of a learner may be determined or estimated. Block 902 may be followed by block 904.

At block 904, a first vocabulary level of a first chunk in an electronic document read by the learner may be determined. Block 904 may be followed by block 906.

At block 906, the current level of vocabulary knowledge of the learner may be compared with the first vocabulary level of the first chunk. Block 906 may be followed by block 908.

At block 908, it may be determined whether the first chunk is associated with one or more topics covered in one or more electronic documents read by the learner. Block 908 may be followed by block 910.

At block 910, it may be determined whether to replace, in the electronic document, the first chunk with a second chunk that has a second vocabulary level based on the comparison of the current level of vocabulary knowledge of the learner with the first vocabulary level and based on whether the first chunk is associated with the topics.

Modifications, additions, or omissions may be made to the method 900 without departing from the scope of the present disclosure. For example, the functions performed in the method 900 may be implemented in differing order. Furthermore, the outlined acts and operations are only provided as examples, and some of the acts and operations may be optional, combined into fewer acts and operations, or expanded into additional acts and operations without detracting from the essence of the disclosed embodiments.

One skilled in the art will appreciate that, for this and other processes and methods disclosed in the present disclosure, the functions performed in the processes and methods may be implemented in differing order. Furthermore, the outlined acts and operations are only provided as examples, and some of the acts and operations may be optional, combined into fewer acts and operations, or expanded into additional acts and operations without detracting from the essence of the disclosed embodiments.

As indicated above, the embodiments described in the present disclosure may include the use of a special purpose or general purpose computer including various computer hardware or software modules, as discussed in greater detail below. Further, as indicated above, embodiments described in the present disclosure may be implemented using computer-readable media for carrying or having computer-executable instructions or data structures stored thereon.

As used in the present disclosure, the terms “module” or “component” may refer to specific hardware embodiments configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware embodiments or a combination of software and specific hardware embodiments are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
estimating a current level of vocabulary knowledge of a learner;
determining a first vocabulary level of a first chunk in an electronic document read by the learner;
comparing the current level of vocabulary knowledge of the learner with the first vocabulary level of the first chunk;
determining whether the first chunk is associated with one or more topics covered in one or more electronic documents read by the learner; and
determining whether to replace, in the electronic document, the first chunk with a second chunk of a vocabulary database based on the comparison of the current level with the first vocabulary level and based on whether the first chunk is associated with the one or more topics, wherein the second chunk has a second vocabulary level.

2. The method of claim 1, further comprising:
determining that the first vocabulary level is higher than the current level based on comparing the current level with the first vocabulary level; and
replacing the first chunk with the second chunk based on the second vocabulary level being at or below the current level and based on determining that the first vocabulary level is higher than the current level.

3. The method of claim 2, further comprising:
determining that the first chunk is not associated with the one or more topics; and
replacing the first chunk with the second chunk based on determining that the first chunk is not associated with the one or more topics.

4. The method of claim 1, further comprising:
determining that the first vocabulary level is higher than the current level based on comparing the current level with the first vocabulary level;
determining that the first chunk is associated with the one or more topics; and
determining not to replace the first chunk with the second chunk based on determining that the first chunk is associated with the one or more topics.

5. The method of claim 1, further comprising:
determining that the first vocabulary level is at or below the current level based on comparing the current level with the first vocabulary level; and
replacing the first chunk with the second chunk based on the second vocabulary level being higher than the current level and based on determining that the first vocabulary level is at or below the current level.

6. The method of claim 5, further comprising:
determining that the first chunk is associated with the one or more topics; and
replacing the first chunk with the second chunk based on determining that the first chunk is associated with the one or more topics.

7. The method of claim 1, further comprising:
determining that the first vocabulary level is at or below the current level based on comparing the current level with the first vocabulary level;
determining that the first chunk is not associated with the one or more topics; and
determining not to replace the first chunk with the second chunk based on determining that the first chunk is not associated with the one or more topics.

8. The method of claim 1, further comprising:
determining a diligence level of the learner based on a duration time between a marking of one or more chunks of a personal vocabulary profile of the learner as unstable chunks and a changing of the marking of the one or more chunks from being marked as unstable chunks to being marked as stable chunks in the personal vocabulary profile, wherein the changing of the marking of the one or more chunks from unstable to stable is in response to determining that the learner has mastered the one or more chunks; and
replacing the first chunk with the second chunk based on the diligence level of the learner.

9. The method of claim 8, further comprising determining that the learner has mastered the one or more chunks in response to confidence values included in the personal vocabulary profile and associated with each of the one or more chunks reaching a counter threshold value.

10. The method of claim 8, further comprising:
determining a ratio of chunks marked stable (“stable chunks”) in the personal vocabulary profile with respect to chunks marked unstable (“unstable chunks”) in the personal vocabulary profile, wherein the stable chunks are marked stable based on a determination that the learner has mastered the stable chunks and the unstable chunks are marked unstable based on a determination that the learner has not mastered the unstable chunks,
wherein determining the diligence level of the learner comprises dividing the ratio by the duration of time.

11. Computer-readable storage media including computer-executable instructions configured to cause a system to perform operations, the operations comprising:
estimating a current level of vocabulary knowledge of a learner;
determining a first vocabulary level of a first chunk in an electronic document read by the learner;
comparing the current level of vocabulary knowledge of the learner with the first vocabulary level of the first chunk; and
determining whether to replace, in the electronic document, the first chunk with a second chunk of a vocabulary database based on the comparison of the current level with the first vocabulary level, wherein the second chunk has a second vocabulary level.

12. The computer-readable storage media of claim 11, the operations further comprising:
determining that the first vocabulary level is higher than the current level based on comparing the current level with the first vocabulary level; and
replacing the first chunk with the second chunk based on the second vocabulary level being at or below the current level and based on determining that the first vocabulary level is higher than the current level.

13. The computer-readable storage media of claim 12, the operations further comprising:
determining that the first chunk is not associated with one or more topics covered in one or more electronic documents read by the learner; and
replacing the first chunk with the second chunk based on determining that the first chunk is not associated with the one or more topics.

14. The computer-readable storage media of claim 11, the operations further comprising:
determining that the first vocabulary level is higher than the current level based on comparing the current level with the first vocabulary level;
determining that the first chunk is associated with one or more topics covered in one or more electronic documents read by the learner; and
determining not to replace the first chunk with the second chunk based on determining that the first chunk is associated with the one or more topics.

15. The computer-readable storage media of claim 11, the operations further comprising:
determining that the first vocabulary level is at or below the current level based on comparing the current level with the first vocabulary level; and
replacing the first chunk with the second chunk based on the second vocabulary level being higher than the current level and based on determining that the first vocabulary level is at or below the current level.

16. The computer-readable storage media of claim 15, the operations further comprising:
determining that the first chunk is associated with one or more topics covered in one or more electronic documents read by the learner; and
replacing the first chunk with the second chunk based on determining that the first chunk is associated with the one or more topics.

17. The computer-readable storage media of claim 11, the operations further comprising:
determining that the first vocabulary level is at or below the current level based on comparing the current level with the first vocabulary level;
determining that the first chunk is not associated with one or more topics covered in one or more electronic documents read by the learner; and
determining not to replace the first chunk with the second chunk based on determining that the first chunk is not associated with the one or more topics.

18. The computer-readable storage media of claim 11, the operations further comprising:
determining a diligence level of the learner based on a duration time between a marking of one or more chunks of a personal vocabulary profile of the learner as unstable chunks and a changing of the marking of the one or more chunks from being marked as unstable chunks to being marked as stable chunks in the personal vocabulary profile, wherein the changing of the marking of the one or more chunks from unstable to stable is in response to determining that the learner has mastered the one or more chunks; and
replacing the first chunk with the second chunk based on the diligence level of the learner.

19. The computer-readable storage media of claim 18, the operations further comprising:
determining a ratio of chunks marked stable (“stable chunks”) in the personal vocabulary profile with respect to chunks marked unstable (“unstable chunks”) in the personal vocabulary profile, wherein the stable chunks are marked stable based on a determination that the learner has mastered the stable chunks and the unstable chunks are marked unstable based on a determination that the learner has not mastered the unstable chunks,
wherein determining the diligence level of the learner comprises dividing the ratio by the duration of time.

20. A method comprising:
estimating a current level of vocabulary knowledge of a learner;
determining a first vocabulary level of a first chunk in an electronic document read by the learner;
comparing the current level of vocabulary knowledge of the learner with the first vocabulary level of the first chunk;
determining a diligence level of the learner based on a duration time between a marking of one or more chunks of a personal vocabulary profile of the learner as unstable chunks and a changing of the marking of the one or more chunks from being marked as unstable chunks to being marked as stable chunks in the personal vocabulary profile, wherein the changing of the marking of the one or more chunks from unstable to stable is in response to determining that the learner has mastered the one or more chunks; and
determining whether to replace, in the electronic document, the first chunk with a second chunk of a vocabulary database based on the diligence level of the learner, wherein the second chunk has a second vocabulary level.
